(19) United States
(12) Patent Application Publication
(10) Pub. No.: US 2021/0029401 A1
(43) Pub. Date: Jan. 28, 2021

(54) REMOTE ADJUSTMENT OF VIDEO FEED

(71) Applicant: DENIS LEVKOVICH, Washington, DC (US)

(72) Inventor: DENIS LEVKOVICH, Washington, DC (US)

(73) Assignee: Feature Story USA Corp, Washington, DC (US)

(21) Appl. No.: 16/602,022

(22) Filed: Jul. 23, 2019

(51) Int. Cl. H04N 21/262; H04N 21/2187; H04N 21/24; H04N 21/218

(52) U.S. Cl. CPC H04N 21/26258; H04N 21/2181; H04N 21/2407; H04N 21/2187

(57) ABSTRACT

An example operation may include one or more of receiving, by a virtual controller, a feed booking request, providing, by the virtual controller, the feed booking request to a scheduling controller, detecting an activation of a streaming device to initiate a scheduled feed corresponding to the feed booking request, responsive to the activation of the streaming device, analyzing the scheduled feed produced based on current settings of the streaming device, and dynamically adjusting, by the virtual controller, the current setting's based on the analysis of the scheduled feed.

### TECHNICAL FIELD

This application generally relates to providing live video feeds from a mobile device at location, and more particularly, to a remote adjustment of the live video feeds' settings.

### BACKGROUND

Increased quality of mobile devices' (e.g., smartphones') video cameras has made them a first choice for correspondents on locations. The use of the mobile devices for streaming live videos is a common practice for so-called “one-man crews” reporting from various locations on the ground where a large film crew is not available or not able to get to (e.g., war zones, flood areas, fires, earthquakes, and other hard to get to locations, for example, in third-world countries, etc.).

However, the use of mobile devices for live video streaming has a number of problems related to a video stream quality. For example, once a one-man crew correspondent starts a video stream, he or she has no idea how the incoming stream looks at the receiving end (e.g., at a broadcast main station). Additionally, the correspondent cannot make any adjustments to the mobile device camera or to a gamble holding the device, while being “on camera.” Furthermore, the correspondent has absolutely no control over a network path and feed parameters used for the broadcast.

All of these issues may result in a poor broadcast quality and in failed line communications. Meanwhile, an operator at a video rendering location (i.e., in a control room at a broadcasting station) possibly located across the globe can see all video quality deficiencies, but he has no control over the broadcast quality either.

Accordingly, efficient and secure way of remotely adjusting video stream settings on-the-fly is desired.

### SUMMARY

One example embodiment may provide a method that includes one or more of receiving, by a virtual controller, a feed booking request, providing, by the virtual controller, the feed booking request to a scheduling controller, detecting an activation of a streaming device to initiate a scheduled feed corresponding to the feed booking request, responsive to the activation of the streaming device, analyzing the scheduled feed produced based on current settings of the streaming device, and dynamically adjusting, by the virtual controller, the current settings based on the analysis of the scheduled feed.

Another example embodiment may provide a system that includes a processor and memory, wherein the processor is configured to perform one or more of receive a feed booking request, provide the feed booking request to a scheduling controller, detect an activation of a streaming device to initiate a scheduled feed corresponding to the feed booking request, responsive to the activation of the streaming device, analyze the scheduled feed produced based on current settings of the streaming device, and dynamically adjust the current settings based on the analysis of the scheduled feed.

A further example embodiment provides a non-transitory computer readable medium comprising instructions, that when read by a processor, cause the processor to perform one or more of receiving a feed booking request, providing the feed booking request to a scheduling controller, detecting an activation of a streaming device to initiate a scheduled feed corresponding to the feed booking request, responsive to the activation of the streaming device, analyzing the scheduled feed produced based on current settings of the streaming device, and dynamically adjusting the current settings based on the analysis of the scheduled feed.

### BRIEF DESCRIPTION OF THE DRAWINGS

FIG. 1 illustrates a network architecture diagram in accordance to the exemplary embodiments.

FIG. 2 illustrates an example network diagram for remote adjustment of video stream settings by a virtual controller, according to exemplary embodiments.

FIG. 3 illustrates a flow diagram of a method for remote adjustment of live stream, according to example embodiments.

FIG. 4 further illustrates a flow diagram of a method for remote adjustment of live stream, according to example embodiments.

FIG. 5 illustrates an example system that supports one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout least this specification refers to the fact that a particular feature, structure, or characteristic described in connection with the embodiment may be included in at one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow.

In addition, while the term “request” may have been used in the description of embodiments, the application may be applied to many types of network data, such as, a packet, frame, datagram, etc. The term “request” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, systems, components, non-transitory computer readable media, devices, and/or networks, which provide at least one of: a video stream producing mobile device, and a video rendering station and a virtual controller connected to the mobile device in order to remotely adjust the settings of the video stream.

Video settings data may be stored in a database, which maintains data in one single database (e.g., database server) and generally at one particular location. This location is often a central computer, a server CPU, or a mainframe computer. Information stored on a centralized database is typically accessible from multiple different points. A centralized database is easy to manage, maintain, and control, especially for purposes of security because of its single location. Within a centralized database, data redundancy is minimized as a single storing place of all data also implies that a given set of data only has one primary record.

According to the exemplary embodiments, a virtual controller device may be connected to a mobile device (e.g., a smartphone) used for a live broadcast by a correspondent from a location across the globe. Prior to the broadcast, the virtual controller device may receive a feed booking request that contains feed start time, feed duration, point of origination, stream switches identified by a global address and or ID, contact details of the correspondent, and user login credentials for providing the video feed from the location.

Then, the feed booking request may be passed on to a scheduler/controller device that may contact a main station (e.g., a production room server) to schedule the feed. The scheduler/controller device may check the feed request against a database of other feeds scheduled at or around the requested time of the feed. The virtual controller device may constantly monitor a status of the streaming mobile device(s). Once the live feed has started by the mobile device at the location, the virtual controller device may detect the activation of the streaming mobile device and start of the feed. The virtual controller device may acquire current settings of the streaming mobile device. The incoming low latency feed produced with the current settings may be analyzed by the virtual controller device. If the quality of the incoming feed needs to be changed, the virtual controller device may acquire remote control of the streaming mobile device and may dynamically adjust the settings of the streaming mobile device. In one exemplary embodiment, the incoming stream produced based on the adjusted settings may be continuously analyzed in order to adjust the settings of the streaming mobile device further.

According to the exemplary embodiments, the dynamically adjustable setting may include: network setting (e.g., bandwidth, pass, switches, etc.), video signal parameters, video/audio compression, camera lens properties, sound source settings, zoom settings, light sensitivity (i.e., ISO settings), white balance, positioning of an external stabilization device (i.e., yaw and pitch angles of a gimbal). Additionally, the virtual controller device may adjust any of the following parameters: exposure settings, focus, white balance, audio input selector, stream target settings, security parameters of the stream, stream audio parameters, stream transport parameters, stream latency parameters, stream start/stop parameters. In one example, the mobile device settings are stored in a central database. The virtual controller device may access the certain fields in the database and may update the settings. The mobile device may read the updated setting data from the database and may use native APIs to adjust the settings.

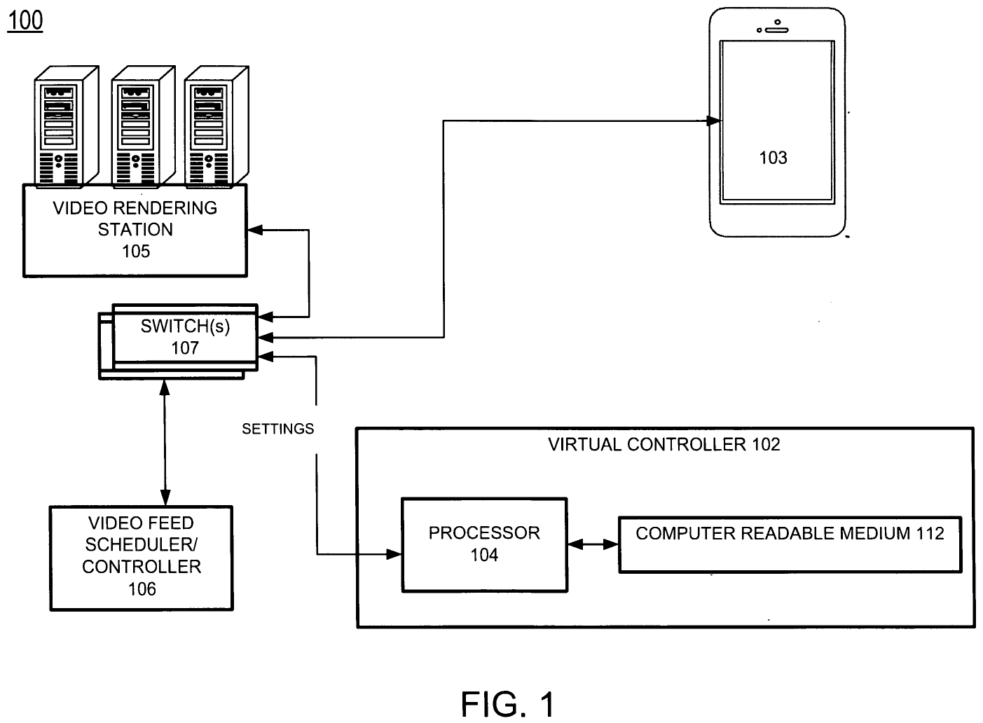

FIG. 1 illustrates an exemplary network architecture diagram 100 that may be used for dynamic adjustment of the video stream acquired by a streaming mobile device.

A virtual controller device 102 may be connected to a mobile device 103 (e.g., a smartphone) used for a live broadcast by a correspondent from a remote location. Prior to the broadcast, the virtual controller device 102 may receive a feed booking request that contains, for example, feed start time, duration, point of origination, stream switches identified by a global address and or ID, contact details of the correspondent, and user login credentials for providing the low latency video feed from the location.

Then, the virtual controller device 102 may pass the feed booking request on to a video feed scheduler/controller device 106 that may contact a video rendering station 105 (e.g., a main broadcasting station or a production room server) to schedule the feed. The feed scheduler/controller device 106 may check the feed request against a database (not shown) of other feeds scheduled at or around the requested time of the feed. The virtual controller device 102 may constantly monitor a status of the streaming mobile device(s) 103. Once the live feed (e.g., a low latency video feed) has started by the mobile device 103 at the location, the virtual controller device may detect the activation of the streaming mobile device and start of the feed. The virtual controller device 102 may acquire current settings of the streaming mobile device 103. The incoming feed produced with the current settings may be analyzed by the virtual controller device 102. If the virtual controller device 102 determines that quality of the incoming feed needs to be changed, the virtual controller device 102 may acquire remote control of the streaming mobile device 103 and may dynamically adjust the settings of the streaming mobile device 103. In one exemplary embodiment, the incoming stream produced based on the adjusted settings may be continuously analyzed by the virtual controller device 102 in order to adjust the settings of the streaming mobile device further. All of the communications between the devices are processed through a series of switches 107.

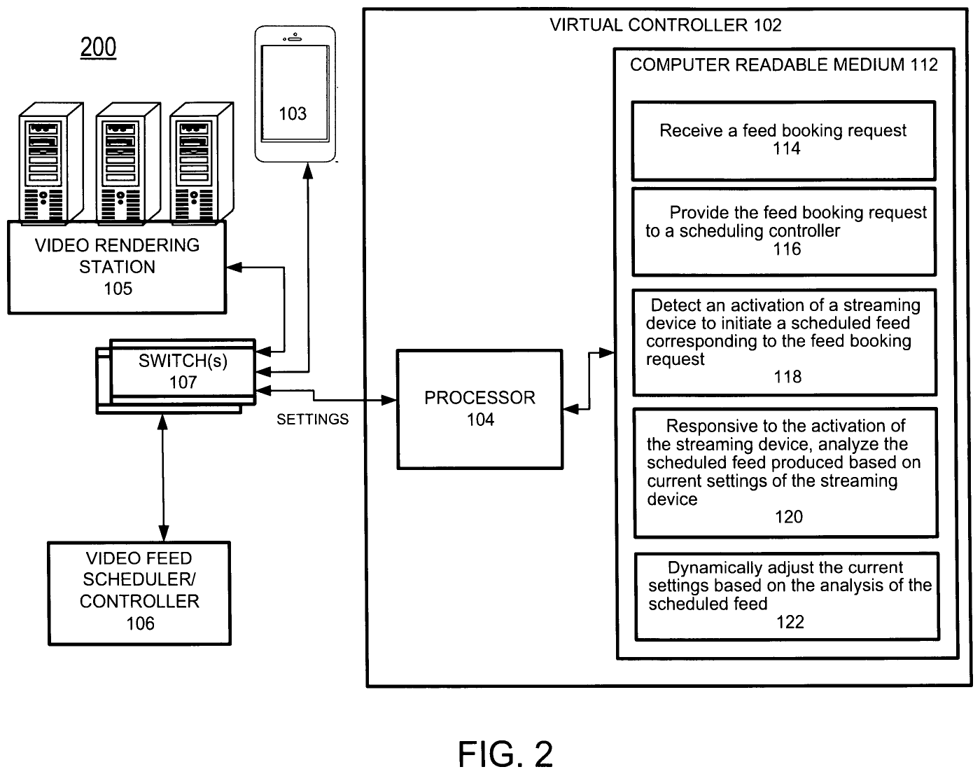

FIG. 2 illustrates a network diagram for a remote adjustment of live video feed settings. Referring to FIG. 2, the network diagram 200 includes a virtual controller 102 connected to the mobile device 103. The virtual controller 102 may also be connected to a settings database. The virtual controller 102 may be connected to the video feed scheduler/controller 106, which is connected to the video rendering station 105 over a network of switches 107. Furthermore, all of the devices may be connected to each other over a network of switches 107. The virtual controller 102 may dynamically and remotely adjust settings of the mobile device 103 based on the quality of the video feed coming into the video rendering station 105.

While this example describes in detail only one virtual controller 102, multiple such nodes may be connected to the network. It should be understood that the virtual controller 102 may include additional components and that some of the components described herein may be removed and/or modified without departing from a scope of the virtual controller 102 disclosed herein. The virtual controller 102 may be a computing device or a server computer, or the like, and may include a processor 104, which may be a semiconductor-based microprocessor, a central processing unit (CPU), an application specific integrated circuit (ASIC), a field-programmable gate array (FPGA), and/or another hardware device. Although a single processor 104 is depicted, it should be understood that the virtual controller 102 may include multiple processors, multiple cores, or the like, without departing from the scope of the virtual controller 102 system.

The virtual controller 102 may also include a non-transitory computer readable medium 112 that may have stored thereon machine-readable instructions executable by the processor 104. Examples of the machine-readable instructions are shown as 114-122 and are further discussed below. Examples of the non-transitory computer readable medium 112 may include an electronic, magnetic, optical, or other physical storage device that contains or stores executable instructions. For example, the non-transitory computer readable medium 112 may be a Random Access memory (RAM), an Electrically Erasable Programmable Read-Only Memory (EEPROM), a hard disk, an optical disc, or other type of storage device.

The processor 104 may execute the machine-readable instructions 114 to receive a feed booking request. As discussed above, a central database may store video stream settings-related data. The processor 104 may execute the machine-readable instructions 116 to provide the feed booking request to a scheduling controller (e.g., 106). The processor 104 may execute the machine-readable instructions to detect an activation of a streaming device 103 to initiate a scheduled feed corresponding to the feed booking request. The processor 104 may execute the machine-readable instructions 120 to, responsive to the activation of the streaming device 103, analyze the scheduled feed produced based on current settings of the streaming device 103. The processor 104 may execute the machine-readable instructions 122 to dynamically adjust the current settings based on the analysis of the scheduled feed.

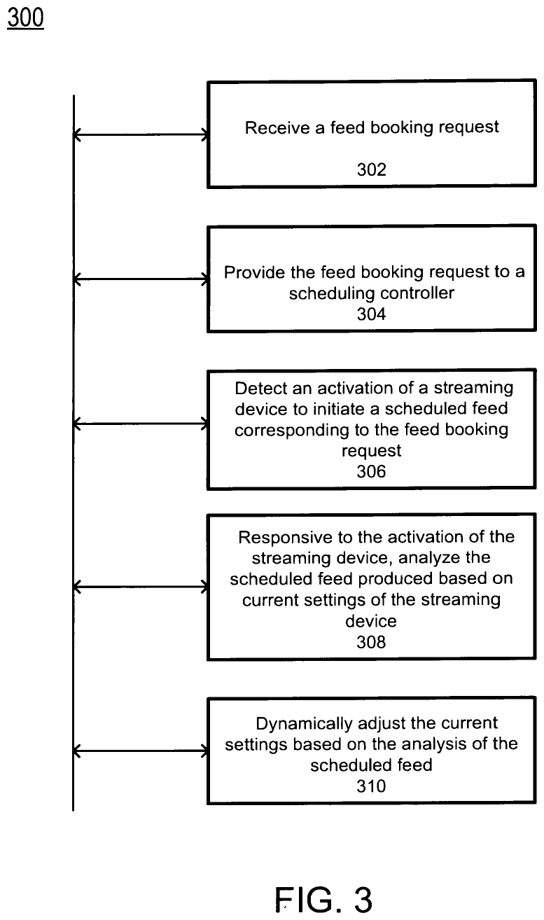

FIG. 3 illustrates a flow diagram 300 of a method for remote adjustment of a live stream, according to example embodiments. Referring to FIG. 3, an example method may be executed by the virtual controller 102 (see FIG. 2). It should be understood that method 300 depicted in FIG. 3 may include additional operations and that some of the operations described therein may be removed and/or modified without departing from the scope of the method 300. The description of the method 300 is also made with reference to the features depicted in FIG. 2 for purposes of illustration. Particularly, the processor 104 of the virtual controller 102 may execute some or all of the operations included in the method 300.

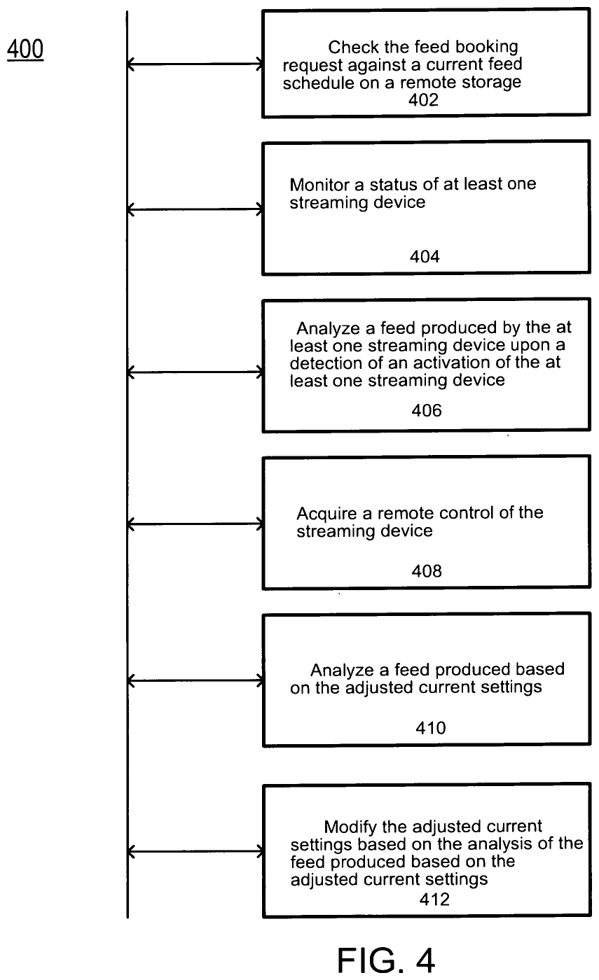

With reference to FIG. 3, at block 302, the processor 104 may receive a feed booking request. At block 304, the processor 104 may provide the feed booking request to a scheduling controller. At block 306, the processor 104 may detect an activation of a streaming device to initiate a scheduled feed corresponding to the feed booking request. At block 308, the processor 104 may, responsive to the activation of the streaming device, analyze the scheduled feed produced based on current settings of the streaming device. At block 310, the processor 104 may dynamically adjust the current settings based on the analysis of the scheduled feed. FIG. 4 illustrates a further flow diagram 400 of an example method, according to the exemplary embodiments. Referring to FIG. 4, the method 400 may also include one or more of the following steps. At block 402, the processor 104 may check the feed booking request against a current feed schedule on a remote storage. At block 404, the processor 104 may monitor a status of at least one streaming device. At block 406, the processor 104 may analyze a feed produced by the at least one streaming device upon a detection of an activation of the at least one streaming device. At block 408, the processor 104 may acquire a remote control of the streaming device. At block 410, the processor 104 may analyze a feed produced based on the adjusted current settings. Then, at block 412, the processor 104 may modify the adjusted current settings based on the analysis of the feed produced based on the adjusted current settings.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

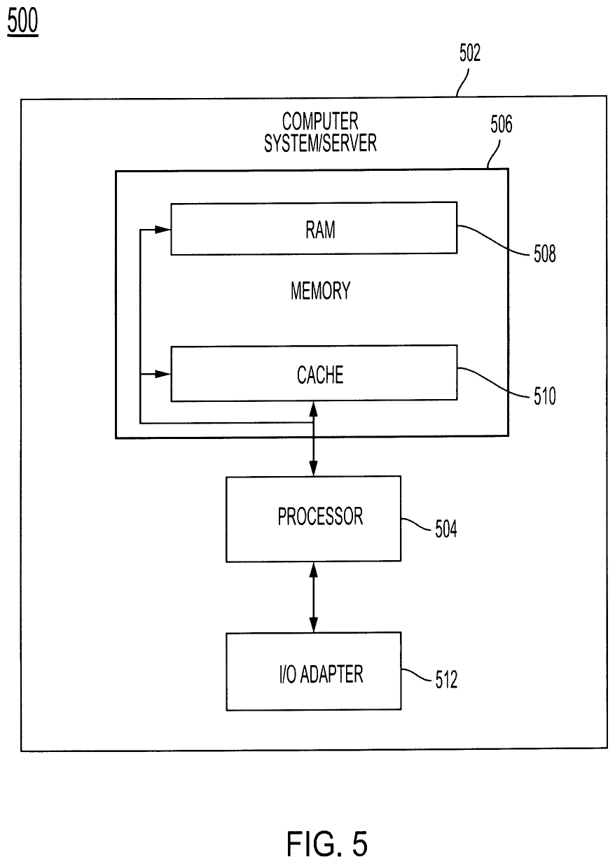

For example, FIG. 5 illustrates an example computer system architecture 500, which may represent or be integrated in any of the above-described components, etc. FIG. 5 is not intended to suggest any limitation as to the scope of use or functionality of embodiments of the application described herein. Regardless, the computing node 500 is capable of being implemented and/or performing any of the functionality set forth hereinabove.

In computing node 500 there is a computer system/server 502, which is operational with numerous other general purpose or special purpose computing system environments or configurations. Examples of well-known computing systems, environments, and/or configurations that may be suitable for use with computer system/server 502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 502 is shown in the form of a general-purpose computing device. The components of computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media. System memory 506, in one embodiment, implements the flow diagrams of the other figures. The system memory 506 can include computer system readable media in the form of volatile memory, such as random-access memory (RAM) 608 and/or cache memory 510. Computer system/server 502 may further include other removable/non-removable, volatile/non-volatile computer system storage media. By way of example only, memory 506 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 506 may include at least one program product having a set (e.g., at least one) of program modules that are configured to carry out the functions of various embodiments of the application.

Program/utility, having a set (at least one) of program modules, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 502 may also communicate with one or more external devices via an I/O adapter 512, such as a keyboard, a pointing device, a display, etc.; one or more devices that enable a user to interact with computer system/server 502; and/or any devices (e.g., network card, modem, etc.) that enable computer system/server 502 to communicate with one or more other computing devices. Such communication can occur via I/O interfaces of the adapter 512. Still yet, computer system/server 502 can communicate with one or more networks such as a local area network (LAN), a general wide area network (WAN), and/or a public network (e.g., the Internet) via a network adapter. As depicted, adapter 512 communicates with the other components of computer system/server 502 via a bus. It should be understood that although not shown, other hardware and/or software components could be used in conjunction with computer system/server 502. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent. While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving, by a virtual controller, a feed booking request;
providing, by the virtual controller, the feed booking request to a scheduling controller;
detecting an activation of a streaming device to initiate a scheduled feed corresponding to the feed booking request;
responsive to the activation of the streaming device, analyzing the scheduled feed produced based on current settings of the streaming device; and
dynamically adjusting, by the virtual controller, the current settings based on the analysis of the scheduled feed.

2. The method of claim 1, comprising checking the feed booking request against an existing feed schedule on a remote storage.

3. The method of claim 1, comprising monitoring a status of at least one streaming device.

4. The method of claim 3, comprising analyzing a feed produced by the at least one streaming device upon a detection of an activation of the at least one streaming device.

5. The method of claim 1, comprising acquiring a remote control of the streaming device.

6. The method of claim 1, comprising analyzing a feed produced based on the adjusted current settings.

7. The method of claim 1, comprising modifying the adjusted current settings based on the analysis of the feed produced based on the adjusted current settings.

8. A system, comprising:
a processor of a virtual controller;
a memory on which are stored machine readable instructions that when executed by the processor, cause the processor to:
receive a feed booking request;
provide the feed booking request to a scheduling controller;
detect an activation of a streaming device to initiate a scheduled feed corresponding to the feed booking request;
responsive to the activation of the streaming device, analyze the scheduled feed produced based on current settings of the streaming device; and
dynamically adjust the current settings based on the analysis of the scheduled feed.

9. The system of claim 8, wherein the instructions are further to cause the processor to check the feed booking request against a current feed schedule on a remote storage.

10. The system of claim 8, wherein the instructions are further to cause the processor to monitor a status of at least one streaming device.

11. The system of claim 10, wherein the instructions are further to cause the processor to analyze a feed produced by the at least one streaming device upon a detection of an activation of the at least one streaming device.

12. The system of claim 8, the instructions are further to cause the processor to acquire a remote control of the streaming device.

13. The system of claim 8, wherein the instructions are further to cause the processor to analyze a feed produced based on the adjusted current settings.

14. The system of claim 13, wherein the instructions are further to cause the processor to modify the adjusted current settings based on the analysis of the feed produced based on the Adjusted current settings.

15. A non-transitory computer readable medium comprising instructions, that when read by a processor, cause the processor to perform:
receiving a feed booking request;
providing the feed booking request to a scheduling controller;
detecting an activation of a streaming device to initiate a scheduled feed corresponding to the feed booking request;
responsive to the activation of the streaming device, analyzing the scheduled feed produced based on current settings of the streaming device; and
dynamically adjusting the current settings based on the analysis of the scheduled feed.

16. The non-transitory computer readable medium of claim 15, further comprising instructions, that when read by a processor, cause the processor to check the feed booking request against a current feed schedule on a remote storage.

17. The non-transitory computer readable medium of claim 15, further comprising instructions, that when read by a processor, cause the processor to monitor a status of at least one streaming device.

18. The non-transitory computer readable medium of claim 17, further comprising instructions, that when read by a processor, cause the processor to analyze a feed produced by the at least one streaming device upon a detection of an activation of the at least one streaming device.

19. The non-transitory computer readable medium of claim 15, further comprising instructions, that when read by a processor, cause the processor to acquire a remote control of the streaming device.

20. The non-transitory computer readable medium of claim 15, further comprising instructions, that when read by a processor, cause the processor to analyze a feed produced based on the adjusted current settings and to modify the adjusted current settings based on the analysis of the feed produced based on the adjusted current settings.
